(19) United States
(12) Patent Application Publication
(10) Pub. No.: US 2025/0370187 A1
(43) Pub. Date: Dec. 4, 2025

(54) GLASS COMPONENT AND METHOD OF MANUFACTURING GLASS COMPONENT

(71) Applicant: SUMITOMO ELECTRIC INDUSTRIES, LTD., Osaka-shi (JP)

(72) Inventor: Hajime ARAO, Osaka-shi (JP)

(73) Assignee: SUMITOMO ELECTRIC INDUSTRIES, LTD., Osaka-shi (JP)

(21) Appl. No.: 19/185,725

(22) Filed: Apr. 22, 2025

(30) Foreign Application Priority Data
Jun. 4, 2024 (JP) 2024-090531

(51) Int. Cl. G02B 6/122; G02B 6/136; G02B 6/14; G02B 6/30

(52) U.S. Cl. CPC G02B 6/1228; G02B 6/136; G02B 6/14; G02B 6/305

(57) ABSTRACT

A glass component includes an optical waveguide. The optical waveguide is provided inside a glass substrate and has a first end and a second end opposite to the first end. The optical waveguide has a plurality of modified regions arranged in a direction intersecting a light guiding direction, and an assembly of the plurality of modified regions forms the optical waveguide. The optical waveguide has a refractive index higher than a refractive index of a region around the optical waveguide by having the plurality of modified regions. A center-to-center spacing between the plurality of modified regions at the first end is larger than a center-to-center spacing between the plurality of modified regions at the second end. An average refractive index of the optical waveguide at the first end is smaller than an average refractive index of the optical waveguide at the second end.

### CROSS REFERENCE TO RELATED APPLICATIONS

This application claims priority based on Japanese Patent Application No. 2024-090531 filed on Jun. 4, 2024, and the entire contents of the Japanese patent application are incorporated herein by reference.

### TECHNICAL FIELD

The present disclosure relates to a glass component and a method of manufacturing a glass component.

### BACKGROUND

Patent literature 1 (U.S. Patent Application Publication No. 2020/0109084) discloses a technique of forming an optical waveguide by irradiating a glass plate with a laser beam having a pulse width of femtosecond order. The patent literature discloses that a region where the refractive index increases can be widened by irradiating a laser beam over a plurality of rows. Non-patent literature 1 (Zhengming Liu et al., “Fabrication of an Optical Waveguide-Mode-Field Compressor in Glass Using a Femtosecond Laser” Materials, Volume 11, No. 1926, 2018) discloses that a low refractive index portion called a “tapered structure” is provided on a side of an optical waveguide in order to change the refractive index difference of the optical waveguide formed by using a laser beam having the pulse width of femtosecond order.

### SUMMARY

A glass component according to an embodiment of the present disclosure includes an optical waveguide provided inside the glass substrate and having a first end and a second end opposite to the first end. The optical waveguide has a plurality of modified regions arranged in a direction intersecting a light guiding direction, and an assembly of the plurality of modified regions forms the optical waveguide. The optical waveguide has a refractive index higher than a refractive index of a region around the optical waveguide by having the plurality of modified regions. A center-to-center spacing between the plurality of modified regions at the first end is larger than a center-to-center spacing between the plurality of modified regions at the second end. An average refractive index of the optical waveguide at the first end is smaller than an average refractive index of the optical waveguide at the second end. A mode field diameter of the first end of the optical waveguide in an arrangement direction of the plurality of modified regions is larger than a mode field diameter of the second end of the optical waveguide in an arrangement direction of the plurality of modified regions.

### BRIEF DESCRIPTION OF THE DRAWINGS

FIG. 1 is a top surface view of a glass component according to a first embodiment of the present disclosure.

FIG. 2 is a front view showing an end surface of a glass component 1.

FIG. 3 is a rear view showing an end surface of the glass component 1.

FIG. 4 is a diagram showing a step of forming a plurality of modified regions.

FIG. 5 is a graph showing the relationship between the refractive index difference (%) between the actually produced optical waveguide and its surroundings, and the center-to-center spacing of the modified region (scan pitch, m).

FIG. 6 is a micrograph showing a plurality of modified regions actually produced and etched with hydrofluoric acid.

FIG. 7 is a side view showing a glass component according to a modification of an embodiment.

FIG. 8 is a front view showing an end surface of a glass component.

FIG. 9 is a rear view showing an end surface of a glass component.

### DETAILED DESCRIPTION

It may be necessary to couple two optical waveguides to each other, each having a different width. For example, with the development of optical circuit technology (silicon photonics) in recent years, it is required to couple an optical fiber to an optical waveguide on a silicon substrate. Since a mode field diameter of light propagating through an optical waveguide on a silicon substrate is different from a mode field diameter of light propagating through an optical fiber, it is desirable to change the mode field diameter of the propagating light in order to efficiently couple them.

In this regard, a technique of forming an optical waveguide by irradiating a glass substrate with a laser beam having a pulse width of femtosecond order is known. For example, a mode field diameter of propagating light can be changed by changing the refractive index difference of the optical waveguide in the light guiding direction using the technique described in non-patent literature 1. However, the technique described in non-patent literature 1 has a problem that the loss of the propagation light increases in a region where an electric field of the propagation light overlaps with the tapered structure. It is presumed that the tapered structure is formed by the destruction of the glass structure by a high-intensity laser beam. Thus, when the propagating light comes into contact with the tapered structure, scattering may occur there, which leads to optical loss.

An object of present disclosure is to provide a glass component and a method of manufacturing a glass component that can change a mode field diameter of light propagating through an optical waveguide and reduce optical loss.

### DESCRIPTION OF EMBODIMENTS OF PRESENT DISCLOSURE

First, the contents of embodiments of the present disclosure will be listed and explained.

[1]A glass component according to an embodiment of the present disclosure includes a glass substrate, and an optical waveguide provided inside the glass substrate and having a first end and a second end opposite to the first end. The optical waveguide has a plurality of modified regions arranged in a direction intersecting a light guiding direction, and an assembly of the plurality of modified regions forms the optical waveguide. The optical waveguide has a refractive index higher than a refractive index of a region around the optical waveguide by having the plurality of modified regions. A center-to-center spacing between the plurality of modified regions at the first end is larger than a center-to-center spacing between the plurality of modified regions at the second end. An average refractive index of the optical waveguide at the first end is smaller than an average refractive index of the optical waveguide at the second end. A mode field diameter of the first end of the optical waveguide in an arrangement direction of the plurality of modified regions is larger than a mode field diameter of the second of the optical waveguide in an arrangement direction of the plurality of modified regions.

In this glass component, the center-to-center spacing between the plurality of modified regions at the first end is larger than the center-to-center spacing between the plurality of modified regions at the second end. As the center-to-center spacing between the plurality of modified regions increases, the width of the optical waveguide increases, while the density of the modified regions decreases, and thus the average refractive index decreases. Further, as the center-to-center spacing between the plurality of modified regions decreases, the width of the optical waveguide decreases, while the density of the modified regions increases, and thus the average refractive index increases. Thus, according to the glass component, the mode field diameter of the waveguide light at the first end can be set to be larger than the mode field diameter of the waveguide light at the second end. Further, the glass component does not require a scattering element existing around the optical waveguide, such as the tapered structure disclosed in non-patent literature 1. Thus, according to the glass component, the mode field diameter of light propagating through the optical waveguide can be changed and the optical loss can be reduced.

[2] In the glass component according to the above [1], the plurality of modified regions may be one-dimensionally arranged in a cross section of the first end, the cross section being perpendicular to the light guiding direction. The plurality of modified regions may be two-dimensionally arranged in a cross section of the second end, the cross section being perpendicular to the light guiding direction. In this case, the degree of freedom of the cross section shape of the optical waveguide can be increased.

[3] In the glass component according to the above [1], the plurality of modified regions may be one-dimensionally arranged in a cross section of the second end, the cross section being perpendicular to the light guiding direction. The plurality of modified regions may be two-dimensionally arranged in a cross section of the first end, the cross section being perpendicular to the light guiding direction. In this case, the degree of freedom of the cross section shape of the optical waveguide can be increased.

[4] In the glass component according to the above [1] to [3], a ratio (P1/P2) of a center-to-center spacing P1 between the plurality of modified regions at the first end to a center-to-center spacing P2 between the plurality of modified regions at the second end may be 1.0 to 4.0. According to the glass component of the above [1], for example, the center-to-center spacing between in such a range can be changed.

[5]A method of manufacturing a glass component according to an embodiment of the present disclosure is a method of manufacturing a glass component including an optical waveguide, and the optical waveguide is provided inside the glass component and having a first end and a second end opposite to the first end. The method includes: forming a plurality of modified regions inside a glass substrate such that the plurality of modified regions are arranged in a direction intersecting a light guiding direction of the optical waveguide. An assembly of the plurality of modified regions forms the optical waveguide. In the forming, focusing a laser beam having a pulse width of a femtosecond order at a focusing point inside the glass substrate while moving the focusing point in the light guiding direction is repeated multiple times while displacing a position of the focusing point so as to form the plurality of modified regions. In the forming, a center-to-center spacing between the plurality of modified regions at the first end is set to be larger than a center-to-center spacing between the plurality of modified regions at the second end. According to this manufacturing method, as in the case of the glass component of the above [1], the mode field diameter of light propagating through the optical waveguide can be changed and the optical loss can be reduced.

### DETAILS OF EMBODIMENTS OF PRESENT DISCLOSURE

Specific examples of the present disclosure will be described below with reference to the drawings. It is noted that, the present disclosure is not limited to the examples, but is defined by the scope of the claims, and is intended to include all modifications within the meaning and scope equivalent to the scope of the claims. In the following description, the same elements are denoted by the same reference numerals in the description of the drawings, and redundant description will be omitted.

### First Embodiment

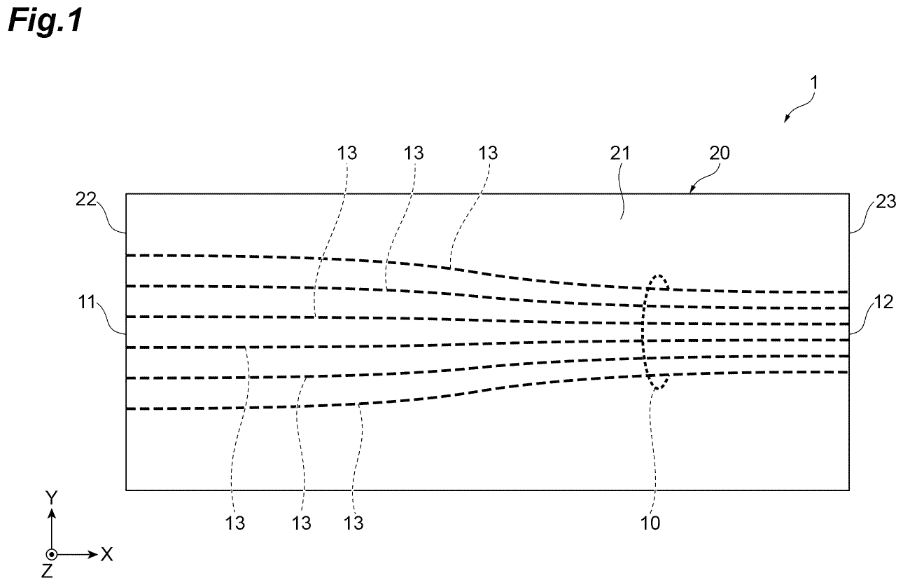

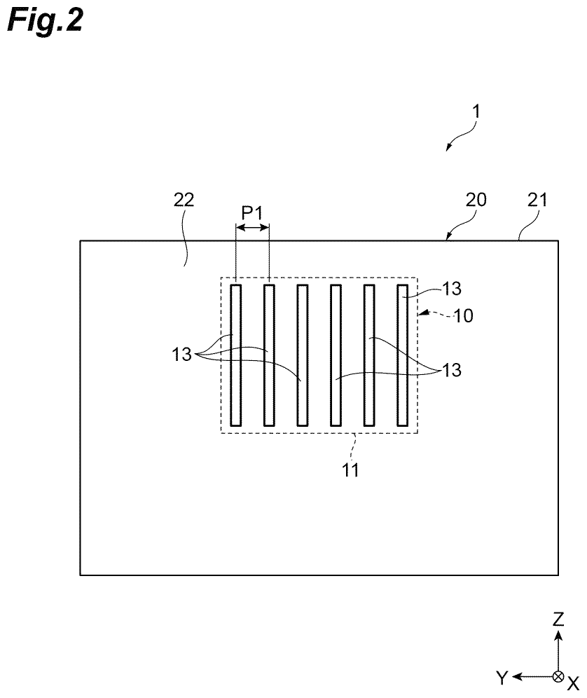

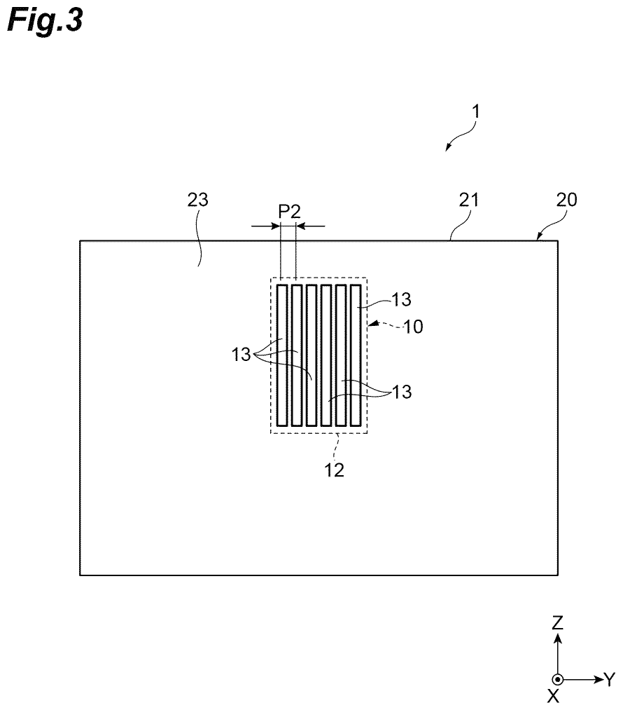

FIG. 1 is a top surface view of a glass component 1 according to a first embodiment of the present disclosure. FIG. 2 is a front view showing an end surface 22 of the glass component 1. FIG. 3 is a rear view showing an end surface 23 of the glass component 1. In these drawings, an XYZ orthogonal coordinate system is shown for easy understanding.

The glass component 1 includes a glass substrate 20 and an optical waveguide 10. The glass substrate 20 is, for example, plate-shaped or rectangular parallelepiped, and has a top surface 21, the end surface 22, and the end surface 23. The top surface 21, the end surface 22, and the end surface 23 are, for example, flat surfaces. The top surface 21 has, for example a rectangular planar shape. The end surface 22 and the end surface 23 are arranged in the direction (X direction) along a long side of the top surface 21 and are oriented in opposite directions to each other. The end surface 22 and the end surface 23 may be parallel to each other or may be inclined to each other. The end surface 22 and the end surface 23 may be perpendicular to the top surface 21 or may be inclined with respect to the top surface 21. The material of the glass substrate 20 is, for example, quartz glass, alkali-free glass (for example, EAGLE XG (registered trademark)), or borosilicate glass (for example, TEMPAX Float (registered trademark)).

The optical waveguide 10 is a core formed inside the glass substrate 20 (that is, inside the glass component 1). The optical waveguide 10 extends in a direction (X direction) along the long side of the top surface 21, and propagates light in the direction. The optical waveguide 10 has a first end 11 and a second end 12 opposite to the first end 11. The first end 11 is included in the end surface 22 of the glass substrate 20. The second end 12 is included in the end surface 23 of the glass substrate 20. That is, the optical waveguide 10 reaches the end surface 22 and the end surface 23. The optical waveguide 10 may guide light from the first end 11 to the second end 12, and may guide light from the second end 12 to the first end 11. Although one optical waveguide 10 is shown in the drawings, the glass component 1 may include a plurality of optical waveguides 10. Not limited to this example, the optical waveguide 10 does not have to reach at least one end surface of the end surface 22 or the end surface 23.

The optical waveguide 10 includes a plurality of modified regions 13. Although six modified regions 13 are shown in the drawings, the number of modified regions 13 is not limited to this. Each of the plurality of modified regions 13 is the refractive index change region having a refractive index larger than that of the glass substrate 20 around modified regions 13. Each of the plurality of modified regions 13 is a laser processing region formed by focusing and scanning a laser beam having an extremely short time width of, for example, femtosecond order on the inside of the glass substrate 20, and modifying the glass by multiphoton absorption. When the modified region is formed by such a method, the cross section of the modified region tends to extend in an incident direction of the laser beam. In the present embodiment, as described below, since the laser beam is incident from the top surface 21, the cross section shape of each modified region 13 extends in the normal direction (Z direction) of the top surface 21. Although the cross section of each modified region 13 is shown as a rectangle in the drawings, it may be an ellipse or oval. Further, the plurality of modified regions 13 have substantially the same length in the Z direction, and thus the optical waveguide 10 having a cross section rectangular shape is formed. A width of each modified region 13 in the Y direction is, for example, 0.1 μm to 1.0 μm. A width of each modified region 13 in the Z direction is, for example, 1.0 μm to 10.0 μm.

The plurality of modified regions 13 are arranged in a direction intersecting the light guiding direction. Although the plurality of modified regions 13 are arranged in a row in the Y direction along the top surface 21 in the drawings, the plurality of modified regions 13 may be two-dimensionally arranged in a plane perpendicular to the light guiding direction (X direction). The optical waveguide 10 is formed by assembly of the plurality of modified regions 13. That is, a bundle of the plurality of modified regions 13 forms one optical waveguide 10. The optical waveguide 10 has a refractive index higher than a refractive index of a region (cladding) around the optical waveguide 10 by having the plurality of modified regions 13.

In a cross section at any position in the light guiding direction, the plurality of modified regions 13 in the cross section are arranged at equal intervals. As shown in FIG. 2 and FIG. 3, the center-to-center spacing P1 between the plurality of modified regions 13 at the first end 11 is larger than the center-to-center spacing P2 between the plurality of modified regions 13 at the second end 12. Thus, the center-to-center spacing between the plurality of modified regions 13 gradually becomes small from the first end 11 toward the second end 12. However, the plurality of modified regions 13 extend in parallel to each other at the first end 11 and the vicinity thereof and at the second end 12 and the vicinity thereof.

In one example, the ratio (P1/P2) of the center-to-center spacing P1 at the first end 11 to the center-to-center spacing P2 at the second end 12 is 1.0 to 4.0.

Due to the change in the center-to-center spacing, the density of the plurality of modified regions 13 at the first end 11 is smaller than the density of the plurality of modified regions 13 at the second end 12. Thus, the average refractive index of the optical waveguide 10 at the first end 11 is smaller than the average refractive index of the optical waveguide 10 at the second end 12. Thus, a mode field diameter of the optical waveguide 10 in the arrangement direction (Y direction) of the plurality of modified regions 13 at the first end 11 is larger than a mode field diameter of the optical waveguide 10 in the arrangement direction (Y direction) of the plurality of modified regions 13 at the second end 12. The mode field diameter of the optical waveguide 10 in the Y direction is, for example, 7 μm to 10 μm at a wavelength of 1310 nm. A ratio (D1/D2) of a mode field diameter D1 at the first end 11 to a mode field diameter D2 at the second end 12 is, for example, 1.0 to 4.0 at a wavelength of 1310 nm. A mode field diameter can be measured by, for example, a far-field distribution sweep method.

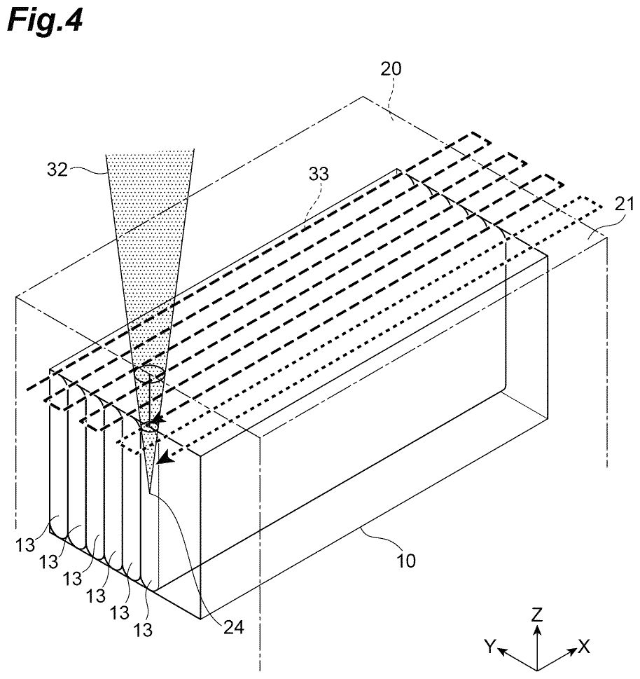

The method of manufacturing the glass component 1 will be described. The manufacturing method includes a step of preparing the glass substrate 20 and a step of forming the plurality of modified regions 13 inside the glass substrate 20. FIG. 4 is a diagram showing the step of forming the plurality of modified regions 13. In this step, a laser beam 32 having a pulse width of a femtosecond order is incident on the inside of the glass substrate 20 from the top surface 21 and focused at a focusing point 24 inside of the glass substrate 20. A wavelength of the laser beam 32 is, for example, 500 nm to 550 nm, 750 nm to 850 nm, or 1000 nm to 1100 nm. A pulse width of the laser beam 32 is, for example, 50 fs to 500 fs. A pulse interval of the laser beam 32 is, for example, 0.1 ns to 100 ns. An average power of the laser beam 32 is, for example, 10 mW to 500 mW. Then, the focusing point 24 is moved (scanned) along the light guiding direction (X direction) while focusing the laser beam 32. A dashed line 33 in the drawing represents a trajectory of the movement of the laser beam 32 on the top surface 21. In this case, when the modified region 13 to be formed is curved, the trajectory of the focusing point 24 will be curved accordingly. This step is repeated the same number of times as the number of modified regions 13 while displacing the position of the focusing point 24 in the Y direction. The amount of displace in the Y direction at this time is referred to as a scan pitch. Thus, the plurality of modified regions 13 are formed inside the glass substrate 20. In this step, as shown in FIG. 2 and FIG. 3, the center-to-center spacing P1 between the plurality of modified regions 13 at the first end 11 is set to be larger than the center-to-center spacing P2 between the plurality of modified regions 13 at the second end 12.

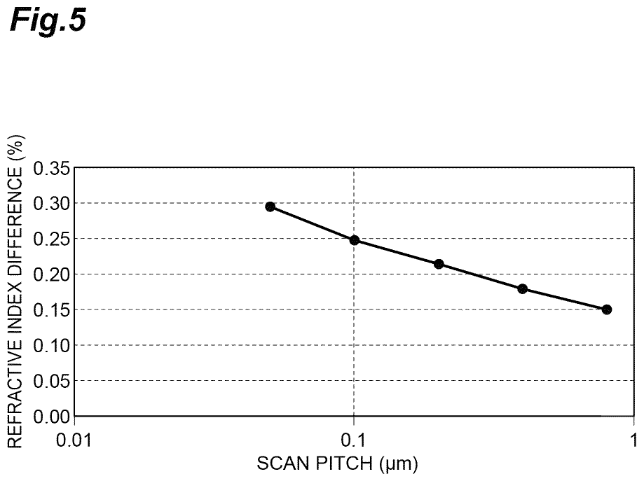

Effects obtained by the glass component 1 and the method of manufacturing the glass component 1 according to the present embodiment described above will be described. In the glass component 1 of the present embodiment, the center-to-center spacing P1 between the plurality of modified regions 13 at the first end 11 is larger than the center-to-center spacing P2 between the plurality of modified regions 13 at the second end 12. As the center-to-center spacing between the plurality of modified regions 13 increases, a width of the optical waveguide 10 increases, while the density of the modified regions 13 decreases, and thus the average refractive index decreases. Further, as the center-to-center spacing between the plurality of modified regions 13 decreases, the width of the optical waveguide 10 decreases, while the density of the modified regions 13 increases, and thus the average refractive index increases. FIG. 5 is a graph showing the relationship between the refractive index difference (%) between the actually produced optical waveguide 10 and its surroundings, and the center-to-center spacing of the modified region 13 (scan pitch, m). Referring to FIG. 5, it can be seen that the refractive index difference increases as the center-to-center spacing between the modified regions 13 are small. The refractive index difference is measured by using, for example, a quantitative phase microscope. The refractive index difference Δn is defined as Δn is equal to (n₁−n₀)/n₀, where n₁ is the refractive index of the optical waveguide 10 and no is the refractive index of the glass substrate 20.

Thus, according to the glass component 1 of the present embodiment and the method of manufacturing the same, the mode field diameter of the waveguide light at the first end 11 can be set to be larger than the mode field diameter of the waveguide light at the second end 12. Further, the glass component 1 does not require a scattering element existing around the optical waveguide 10, such as the tapered structure disclosed in non-patent literature 1. Thus, according to the glass component 1, the mode field diameter of the light propagating through the optical waveguide 10 can be changed and the optical loss can be reduced.

The glass component 1 of the present embodiment is used when converting a mode field diameter, for example. For example, the first end 11 is coupled to a single-mode optical fiber, and the second end 12 is coupled to an optical waveguide of a silicon photonics chip. In general, a mode field diameter of a single-mode optical fiber is larger than a mode field diameter of an optical waveguide of a silicon photonics chip. Further, the refractive index difference of a core of the single-mode optical fiber is smaller than the refractive index difference of the optical waveguide of the silicon photonics chip. The glass component 1 of the present embodiment can suitably convert the mode field diameter and the refractive index difference between the single-mode optical fiber and the silicon photonics chip, and can reduce the optical loss.

As in the present embodiment, the ratio (P1/P2) of the center-to-center spacing P1 between the plurality of modified regions 13 at the first end 11 to the center-to-center spacing P2 between the plurality of modified regions 13 at the second end 12 may be 1.0 to 4.0. According to the glass component 1 of the present embodiment, for example, the center-to-center spacing between in such a range can be changed.

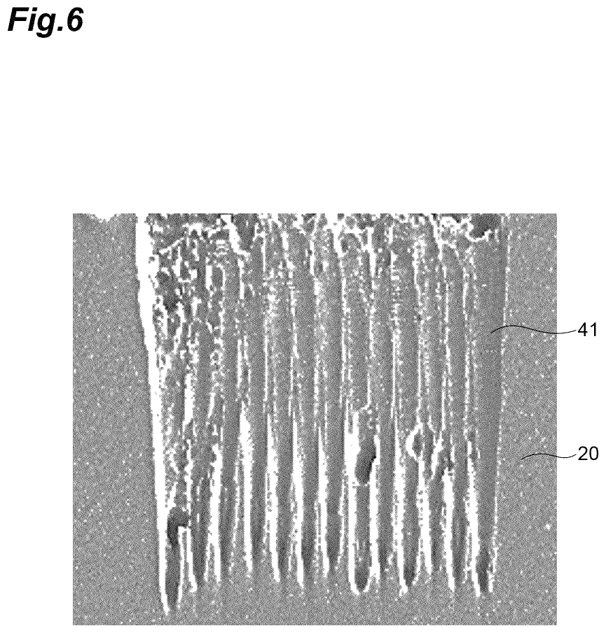

The plurality of modified regions 13 are selectively etched with respect to the around region by using an etchant such as hydrofluoric acid. FIG. 6 is a micrograph showing the plurality of modified regions 13 actually produced and etched with hydrofluoric acid. This photograph shows a plurality of voids 41 formed by etching. The plurality of voids 41 are formed by etching each of the plurality of modified regions 13. As described above, after the plurality of modified regions 13 are formed, it is easy to confirm the center-to-center spacing between the plurality of modified regions 13 and the number of the plurality of modified regions 13.

### Modification

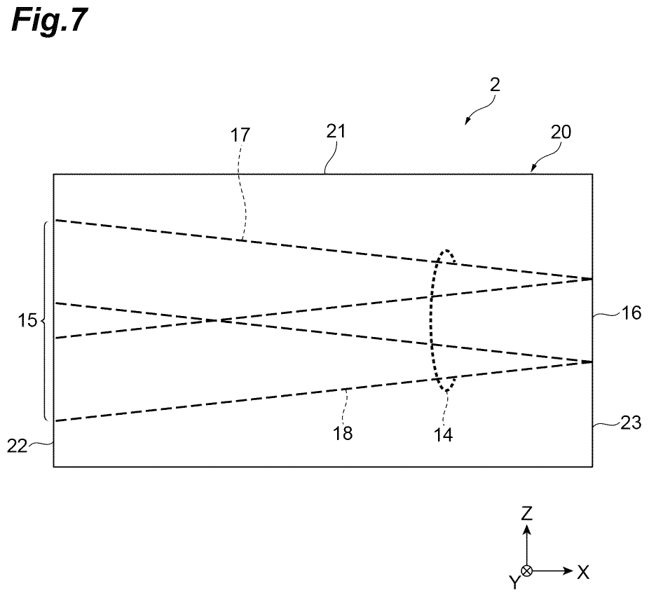

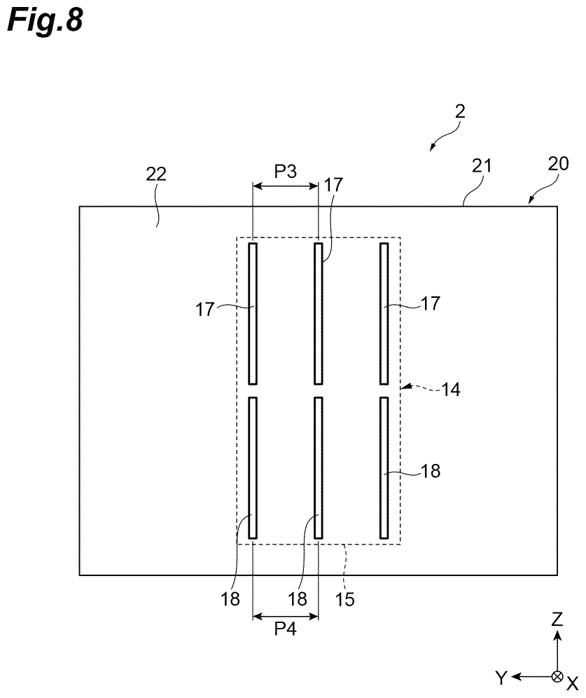

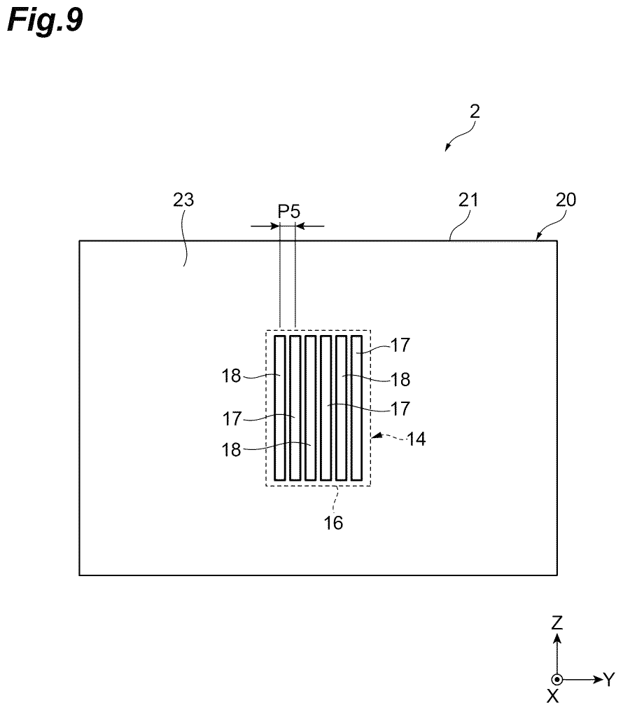

FIG. 7 is a side view showing a glass component 2 according to a modification of an embodiment. FIG. 8 is a front view showing the end surface 22 of the glass component 2. FIG. 9 is a rear view showing the end surface 23 of the glass component 2. In these drawings, an XYZ orthogonal coordinate system is shown for easy understanding.

The glass component 2 of this modification includes an optical waveguide 14 instead of the optical waveguide 10 of the above embodiment. The optical waveguide 14 is formed inside the glass substrate 20 (that is, inside the glass component 2). The optical waveguide 14 extends in a direction (X direction) along the long side of the top surface 21, and propagates light in the direction. The optical waveguide 14 has a first end 15 and a second end 16 opposite to the first end 15. The first end 15 is included in the end surface 22 of the glass substrate 20. The second end 16 is included in the end surface 23 of the glass substrate 20. That is, the optical waveguide 14 reaches the end surface 22 and the end surface 23. The optical waveguide 14 may guide light from the first end 15 to the second end 16, and may guide light from the second end 16 to the first end 15. Although one optical waveguide 14 is shown in the drawings, the glass component 2 may include a plurality of optical waveguides 14. Alternatively, the optical waveguide 10 of the above embodiment may be provided in addition to the optical waveguide 14. Not limited to this modification, the optical waveguide 14 does not have to reach at least one end surface of the end surface 22 or the end surface 23.

The optical waveguide 14 includes a plurality of modified regions 17 and a plurality of modified regions 18. Although three modified regions 17 and three modified regions 18 are shown in drawings, the number of modified regions 17 and 18 are not limited to this. The number of modified regions 17 may be the same as or different from the number of modified regions 18. Each of the modified regions 17 and 18 is formed by the same method as the modified region 13 of the above embodiment. The cross section shape of each of the modified regions 17 and 18 may be the same as the cross section shape of the modified region 13 of the above embodiment.

A plurality of modified regions including the modified regions 17 and 18 are arranged in a direction intersecting the light guiding direction. In this modification, the plurality of modified regions including the modified regions 17 and 18 are one-dimensionally arranged in a cross section of the second end 16 perpendicular to the light guiding direction. Further, the plurality of modified regions including the modified regions 17 and 18 are two-dimensionally arranged in a cross section of the first end 15 perpendicular to the light guiding direction. Specifically, in the second end 16, the modified regions 17 and 18 are alternately arranged in a row along the Y direction. In the first end 15, the modified regions 17 are arranged in a row along the Y direction, and the modified regions 18 are arranged in a row along the Y direction. In the first end 15, a group of the plurality of modified regions 17 and a group of the plurality of modified regions 18 are arranged in the Z direction. Thus, the central axis of the modified region 17 and the central axis of the modified region 18 are inclined with respect to the X direction when viewed along the Y direction (refer to FIG. 7). When viewed along the Y direction, the central axis of the modified region 17 or the central axis of the modified region 18 may be parallel to the X direction. Further, the plurality of modified regions including the modified regions 17 and 18 may be one-dimensionally arranged in a cross section of the first end 15 perpendicular to the light guiding direction, and the plurality of modified regions including the modified regions 17 and 18 may be two-dimensionally arranged in a cross section of the second end 16 perpendicular to the light guiding direction.

The optical waveguide 14 is formed by assembly of the plurality of modified regions including the modified regions 17 and 18. That is, a bundle of a plurality of modified regions forms one optical waveguide 14. The optical waveguide 14 has a refractive index higher than the refractive index of a region around the optical waveguide 14 by having a plurality of modified regions.

As shown in FIG. 8 and FIG. 9, a center-to-center spacing P3 between the plurality of modified regions 17 and a center-to-center spacing P4 between the plurality of modified regions 18 at the first end 15 are larger than a center-to-center spacing P5 between the modified region 17 and the modified region 18 at the second end 16. Due to the change in the center-to-center spacing, the density of the plurality of modified regions at the first end 15 is smaller than the density of the plurality of modified regions at the second end 16. Thus, the average refractive index of the optical waveguide 14 at the first end 15 is smaller than the average refractive index of the optical waveguide 14 at the second end 16. Thus, the mode field diameter of the optical waveguide 14 at the first end 15 is larger than the mode field diameter of the optical waveguide 14 at the second end 16.

As in this modification, the plurality of modified regions may be one-dimensionally arranged in the cross section of the second end 16 perpendicular to the light guiding direction, and the plurality of modified regions may be two-dimensionally arranged in the cross section of the first end 15 perpendicular to the light guiding direction. Alternatively, the plurality of modified regions may be one-dimensionally arranged in the cross section of the first end 15 perpendicular to the light guiding direction, and the plurality of modified regions may be two-dimensionally arranged in the cross section of the second end 16 perpendicular to the light guiding direction. In these cases, the degree of freedom of the cross section shape of the optical waveguide 14 can be increased.

What is claimed is:

1. A glass component comprising:
a glass substrate; and
an optical waveguide provided inside the glass substrate and having a first end and a second end opposite to the first end,
wherein the optical waveguide has a plurality of modified regions arranged in a direction intersecting a light guiding direction, and an assembly of the plurality of modified regions forms the optical waveguide,
wherein the optical waveguide has a refractive index higher than a refractive index of a region around the optical waveguide by having the plurality of modified regions,
wherein a center-to-center spacing between the plurality of modified regions at the first end is larger than a center-to-center spacing between the plurality of modified regions at the second end,
wherein an average refractive index of the optical waveguide at the first end is smaller than an average refractive index of the optical waveguide at the second end, and
wherein a mode field diameter of the first end of the optical waveguide in an arrangement direction of the plurality of modified regions is larger than a mode field diameter of the second end of the optical waveguide in an arrangement direction of the plurality of modified regions.

2. The glass component according to claim 1,
wherein the plurality of modified regions are one-dimensionally arranged in a cross section of the first end, the cross section being perpendicular to the light guiding direction, and
wherein the plurality of modified regions are two-dimensionally arranged in a cross section of the second end, the cross section being perpendicular to the light guiding direction.

3. The glass component according to claim 1,
wherein the plurality of modified regions are one-dimensionally arranged in a cross section of the second end, the cross section being perpendicular to the light guiding direction, and
wherein the plurality of modified regions are two-dimensionally arranged in a cross section of the first end, the cross section being perpendicular to the light guiding direction.

4. The glass component according to claim 1,
wherein a ratio (P1/P2) of a center-to-center spacing P1 between the plurality of modified regions at the first end to a center-to-center spacing P2 between the plurality of modified regions at the second end is 1.0 to 4.0.

5. A method of manufacturing a glass component including an optical waveguide, the optical waveguide being provided inside the glass component and having a first end and a second end opposite to the first end, the method comprising:
forming a plurality of modified regions inside a glass substrate such that the plurality of modified regions are arranged in a direction intersecting a light guiding direction of the optical waveguide,
wherein an assembly of the plurality of modified regions forms the optical waveguide,
wherein, in the forming, focusing a laser beam having a pulse width of a femtosecond order at a focusing point inside the glass substrate while moving the focusing point in the light guiding direction is repeated multiple times while displacing a position of the focusing point so as to form the plurality of modified regions, and
wherein, in the forming, a center-to-center spacing between the plurality of modified regions at the first end is set to be larger than a center-to-center spacing between the plurality of modified regions at the second end.
